(19) United States
(12) Patent Application Publication
(10) Pub. No.: US 2025/0368577 A1
(43) Pub. Date: Dec. 4, 2025

(54) System and Method of Manufacturing Water-Soluble Ceramic Downhole Well Tooling

(71) Applicant: CO2 Convert, LLC, Houston, TX (US)

(72) Inventor: Robert Howard, Houston, TX (US)

(21) Appl. No.: 19/221,224

(22) Filed: May 28, 2025

Related U.S. Application Data
(60) Provisional application No. 63/652,509, filed on May 28, 2024.

(51) Int. Cl. C04B 35/16; B28B 11/04; C04B 35/657; C04B 41/52; C04B 41/89

(52) U.S. Cl. CPC C04B 35/16; C04B 35/657; C04B 41/52; C04B 41/89; B28B 11/04

(57) ABSTRACT

The system and method of manufacturing water-soluble ceramic downhole well tooling enables the manufacturing of sustainable and ecofriendly well tooling that can be disposed of inside downhole wells to eliminate the need for removal processes. A quantity of sodium silicate up is heated to a melting point to form molten sodium silicate ceramic. Once the molten sodium silicate ceramic is obtained, the molten sodium silicate ceramic is poured into the casting mold to shape the molten sodium silicate ceramic to the desired tool piece shape. Then, the molten sodium silicate ceramic is cooled within the casting mold to form the specific tool piece. Once cooled, the specific tool piece is removed from the casting mold to separate the formed tool piece from the casting mold. Finally, the primary quantity of ceramic refractory coating is applied to the specific tool piece to form a primary external coat layer.

### FIELD OF THE INVENTION

The present invention relates generally to water soluble materials and downhole well tooling. More specifically, the present invention discloses novel means to manufacture downhole well tooling made from water-soluble materials.

### BACKGROUND OF THE INVENTION

Nowadays, different types of downhole mining are practiced throughout the world. For example, geothermal wells tap into the Earth's natural heat to generate electricity or provide heating and cooling. The formation of geothermal wells typically involve drilling deep into the Earth's crust to access hot rocks or reservoirs of steam or hot water. The operating conditions of downhole mining can be very extreme and require special solutions. For example, high-temperature oil and gas wells involve exceptionally high temperatures during drilling and production operations which require special equipment and materials that can withstand these extreme conditions. However, due to the operating conditions of downhole wells, there are several challenges in removal of the tooling which leads to intricate and time-consuming removal processes.

The objective of the present invention is to offer sustainable, cost-effective, and versatile solutions for temporary downhole applications in high-temperature oil, gas, and geothermal wells. The present invention discloses means to manufacture water-soluble tooling which eliminates the need for tooling removal from a downhole well. The water-soluble tooling of the present invention provides greater benefits over currently available solutions. Beyond performance benefits, water-soluble tooling aligns with sustainability goals by minimizing waste and environmental impact. Unlike traditional tooling that requires chemical or mechanical removal, the tooling of the present invention dissolves harmlessly in water, presenting a cleaner, greener approach to advanced ceramics manufacturing.

### SUMMARY OF THE INVENTION

The present invention provides cutting-edge advancements in materials and manufacturing by disclosing revolutionary water-soluble engineered ceramic, poised to redefine the possibilities of advanced ceramics manufacturing. With enhanced design freedom, streamlined processes, and environmental sustainability, water-soluble tooling represents not just an evolution, but a revolution in ceramic component fabrication. In the preferred embodiment, the present invention discloses means to manufacture water-soluble ceramic tooling including, but not limited to, high-pressure ball valves, balls, seats, collars, cleats, and tooling ceramic cores used in hydraulic fracturing.

Further, the water-soluble tooling of the present invention can endure high pressures greater than 10,000 pounds per square inch (psi) for extended times and then degrade at a predictable time schedule to eliminate the need of tooling removal. The water-soluble tooling is specially designed with multilayered nano ceramic filled coating which serves as a time delay feature that controls when the tooling starts to dissolve.

Further, water-soluble tooling provides greater engineered strength and more durable complex geometric shapes while also promoting sustainability through easy water dissolution. Additional features and benefits of the present invention are further discussed in the sections below.

### BRIEF DESCRIPTION OF THE DRAWINGS

FIG. 1 is an illustration showing the overall system of the present invention.

FIG. 2 is a flowchart showing the overall process of the method of the present invention.

FIG. 3 is a flowchart showing the subprocess of introducing secondary ceramic materials.

FIG. 4 is a flowchart showing the subprocess of adding secondary coat layers.

### DETAIL DESCRIPTIONS OF THE INVENTION

All descriptions are for the purpose of describing selected versions of the present invention and are not intended to limit the scope of the present invention.

The present invention discloses a method of manufacturing water-soluble ceramic downhole well tooling. The water-soluble tooling of the present invention is designed to facilitate the sustainable and ecofriendly disposal of well tooling to eliminate the need for removal of the well tooling.

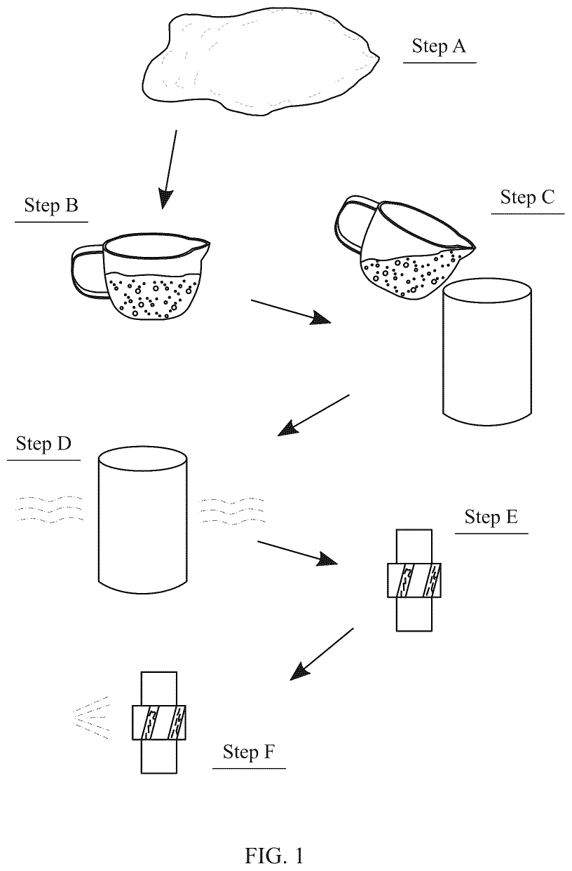

In the preferred embodiment, the system of the present invention includes the use of a quantity of sodium silicate, a primary quantity of ceramic refractory coating, and at least one casting mold (Step A), as can be seen in FIG. 1. The quantity of sodium silicate corresponds to an amount of refined sodium silicate with a high melting point of about 1,400 degrees Celsius (C). The amount of sodium silicate utilized in the process depends on the desired tool piece that is manufactured. The primary quantity of ceramic refractory coating corresponds to the coating material utilized to control the period when the manufactured tooling starts dissolving. Further, the casting mold corresponds to the mold utilized to shape the desired tool piece being manufactured.

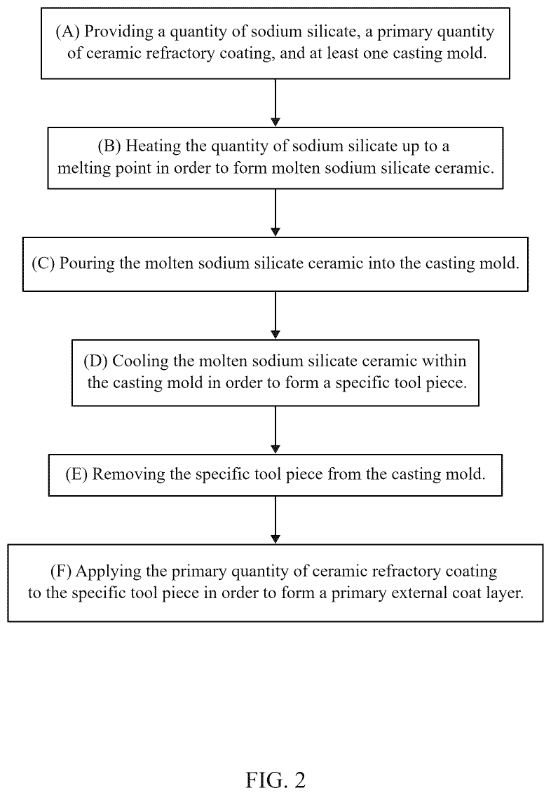

The system of the present invention allows the manufacturing process to take place according to the method of the present invention. As can be seen in FIG. 2, the overall process of the method of the present invention begins by heating the quantity of sodium silicate up to a melting point in order to form molten sodium silicate ceramic (Step B). Different smelting tools can be utilized to heat the quantity of sodium silicate up to the melting point according to the available facilities. Once the molten sodium silicate ceramic is obtained, the molten sodium silicate ceramic is poured into the casting mold (Step C) to shape the molten sodium silicate ceramic to the desired tool piece shape. Then, the molten sodium silicate ceramic is cooled within the casting mold in order to form the specific tool piece (Step D). Different cooling technology can be utilized to accelerate the cooling of the molten sodium silicate ceramic within the casting mold. Once cooled, the specific tool piece is removed from the casting mold (Step E) to separate the formed tool piece from the casting mold. Finally, the primary quantity of ceramic refractory coating is applied to the specific tool piece in order to form a primary external coat layer (Step F).

The use of refined sodium silicate allows the manufacturing of dissolvable and intentionally degradable ceramic tooling designed for use in the development of high-temperature oil and gas wells and geothermal wells. The manufactured ceramic tools are engineered to withstand temperatures exceeding 120° F., with some embodiments capable of operating in environments with temperatures in excess of 500° F. The ceramic pieces of the present invention are suitable for various downhole applications including, but not limited to, tooling, parts, frack balls, and frack plugs.

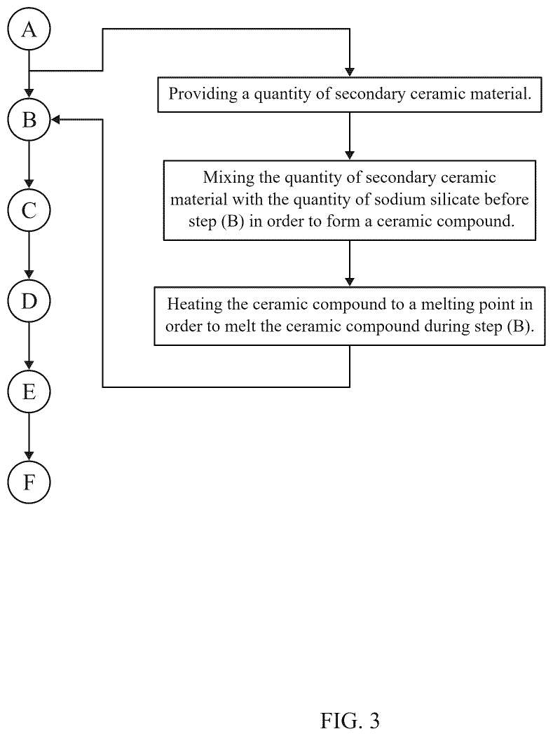

In some embodiments, additional materials may be utilized to manufacture the ceramic pieces that are used to manufacture the desired well tooling. A quantity of secondary ceramic material can be implemented into the manufacturing process. For example, a quantity of water-soluble inorganic salt can be utilized to manufacture the specific tool piece. As can be seen in FIG. 3, the subprocess of introducing secondary ceramic materials includes the steps of mixing the quantity of secondary ceramic material with the quantity of sodium silicate before Step B in order to form a ceramic compound for the specific tool piece. Different tools can be implemented to help mix the sodium silicate and secondary ceramic materials. Further, the ceramic compound is heated to a melting point in order to melt the ceramic compound during Step B. The melted ceramic compound is then processed using the rest of the main manufacturing process to manufacture the specific tool piece.

As previously discussed, the manufactured ceramic tool pieces are soluble in certain application fluids including water. The dissolvable and intentionally degradable ceramic tool pieces can withstand high temperature oil, gas, and geothermal well conditions. The ceramic tool pieces dissolve and degrade in the well fluids and water so that the well tooling with the ceramic tool pieces of the present invention do not have to be removed from the downhole well. The primary external coat layer is designed to degrade when subjected to well fluids and well process waters at elevated well fluid temperatures above 32° C. (90 F).

In the preferred embodiment, the primary external coat layer has a special nanostructure with a thickness in excess of 100 nanometers (nm). The primary external coat layer provides temporary protection from the fracking fluids but degrades when moistened and exposed to heated well fluids on a predictable time schedule. Once the primary external coat layer degrades, well fluids can access the ceramic tool pieces to promote the dissolving of the entire tooling.

The specific tool pieces manufactured using the method of the present invention can be used to make advanced ceramic oil tools. The molten sodium silicate ceramic can be poured to form simple or complex geometries and features as necessary. In addition, together with the primary external coat layer, the manufactured specific tool piece enables faster and safer oil well completions and processing due to predictable dissolve times and improved performance, promoting sustainability fracking practices.

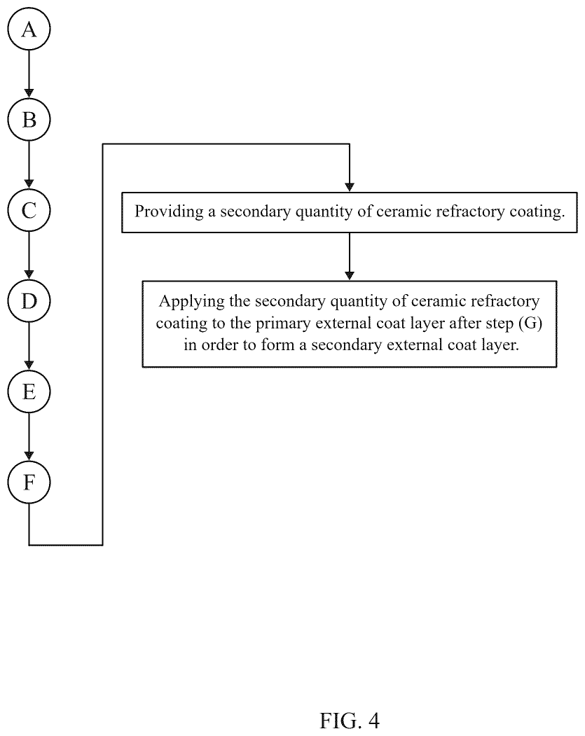

In some embodiments, additional coat layers can be applied to extend the durability of the ceramic tooling manufactured using the specific tool pieces of the present invention. To do so, a secondary quantity of ceramic refractory coating can be utilized to form additional coat layers overlapping the primary external coat layer. As can be seen in FIG. 4, the subprocess of adding secondary coat layers involves applying the secondary quantity of ceramic refractory coating to the primary external coat layer after Step G in order to form a secondary external coat layer. The secondary external coat layer prolongs the dissolution process of the corresponding specific tool piece. Additional external coat layers can be applied as necessary using different coating materials that dissolve when fluids at a specific temperature contact the external coat layers.

The system and method of the present invention result in many benefits to the downhole mining industry. Water-soluble tooling eliminates the need for labor-intensive difficult downhole well tool removal processes, shortening production cycles, reducing lead times, trips into the well, and carbon footprint. In addition, water-soluble tooling dissolves harmlessly in water, minimizing waste and environmental impact, offering a cleaner, greener approach to advanced ceramics manufacturing. Furthermore, the manufacturing process of the method of the present invention enables the creation of complex geometries and internal channels that were once deemed impractical or impossible.

Although the invention has been explained in relation to its preferred embodiment, it is to be understood that many other possible modifications and variations can be made without departing from the spirit and scope of the invention.

What is claimed is:

1. A method of manufacturing water-soluble ceramic downhole well tooling, the methods comprising the steps of:
(A) providing a quantity of sodium silicate, a primary quantity of ceramic refractory coating, and at least one casting mold;
(B) heating the quantity of sodium silicate up to a melting point in order to form molten sodium silicate ceramic;
(C) pouring the molten sodium silicate ceramic into the casting mold;
(D) cooling the molten sodium silicate ceramic within the casting mold in order to form a specific tool piece;
(E) removing the specific tool piece from the casting mold; and
(F) applying the primary quantity of ceramic refractory coating to the specific tool piece in order to form a primary external coat layer.

2. The method as claimed in claim 1 further comprising the steps of:
providing a quantity of secondary ceramic material;
mixing the quantity of secondary ceramic material with the quantity of sodium silicate before step (B) in order to form a ceramic compound; and
heating the ceramic compound to a melting point in order to melt the ceramic compound during step (B).

3. The method as claimed in claim 2, wherein the quantity of secondary ceramic material is a quantity of water-soluble inorganic salt.

4. The method as claimed in claim 1, wherein the primary external coat layer has a thickness in excess of 100 nanometers.

5. The method as claimed in claim 1 further comprising the steps of:
providing a secondary quantity of ceramic refractory coating; and
applying the secondary quantity of ceramic refractory coating to the primary external coat layer after step (G) in order to form a secondary external coat layer.
